(19) United States
(12) Patent Application Publication
(10) Pub. No.: US 2026/0106778 A1
(43) Pub. Date: Apr. 16, 2026

(54) NOISE COVARIANCE MATRIX ESTIMATION REFERENCE SIGNALS

(71) Applicant: QUALCOMM Incorporated, San Diego, CA (US)

(72) Inventors: Chih-Hao LIU, San Diego, CA (US); Jing SUN, San Diego, CA (US); Jing JIANG, San Diego, CA (US); Mostafa KHOSHNEVISAN, San Diego, CA (US)

(21) Appl. No.: 18/915,842

(22) Filed: Oct. 15, 2024

(51) Int. Cl. H04L 25/02; H04L 1/00; H04L 5/00; H04W 72/0446; H04W 72/0453; H04W 72/1273; H04W 72/231

(52) U.S. Cl. CPC H04L 25/021; H04L 1/0003; H04L 5/0051; H04W 72/0446; H04W 72/0453; H04W 72/1273; H04W 72/231

(57) ABSTRACT

Various aspects of the present disclosure generally relate to wireless communication. In some aspects, a user equipment (UE) may receive, in a slot associated with a start and length indicator value (SLIV) that spans multiple slots, a noise covariance matrix estimation reference signal in accordance with a frequency domain window and a time domain window. The UE may transmit a report that indicates an interference from a neighboring cell, wherein the interference is measured in the slot based at least in part on the noise covariance matrix estimation reference signal. Numerous other aspects are described.

### FIELD OF THE DISCLOSURE

Aspects of the present disclosure generally relate to wireless communication and specifically relate to techniques, apparatuses, and methods associated with noise covariance matrix estimation reference signals.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

In some implementations, an apparatus for wireless communication at a user equipment (UE) includes one or more memories; and one or more processors, coupled to the one or more memories, configured to cause the UE to: receive, in a slot associated with a start and length indicator value (SLIV) that spans multiple slots, a noise covariance matrix estimation reference signal in accordance with a frequency domain window and a time domain window; and transmit a report that indicates an interference from a neighboring cell, wherein the interference is measured in the slot based at least in part on the noise covariance matrix estimation reference signal.

In some implementations, an apparatus for wireless communication at a network node includes one or more memories; and one or more processors, coupled to the one or more memories, configured to cause the network node to: transmit, in a slot associated with a SLIV that spans multiple slots, a noise covariance matrix estimation reference signal in accordance with a frequency domain window and a time domain window; and receive a report that indicates an interference from a neighboring cell, wherein the interference is measured in the slot based at least in part on the noise covariance matrix estimation reference signal.

In some implementations, a method of wireless communication performed by a UE includes receiving, in a slot associated with a SLIV that spans multiple slots, a noise covariance matrix estimation reference signal in accordance with a frequency domain window and a time domain window; and transmitting a report that indicates an interference from a neighboring cell, wherein the interference is measured in the slot based at least in part on the noise covariance matrix estimation reference signal.

In some implementations, a method of wireless communication performed by a network node includes transmitting, in a slot associated with a SLIV that spans multiple slots, a noise covariance matrix estimation reference signal in accordance with a frequency domain window and a time domain window; and receiving a report that indicates an interference from a neighboring cell, wherein the interference is measured in the slot based at least in part on the noise covariance matrix estimation reference signal.

In some implementations, a non-transitory computer-readable medium storing a set of instructions for wireless communication includes one or more instructions that, when executed by one or more processors of a UE, cause the UE to: receive, in a slot associated with a SLIV that spans multiple slots, a noise covariance matrix estimation reference signal in accordance with a frequency domain window and a time domain window; and transmit a report that indicates an interference from a neighboring cell, wherein the interference is measured in the slot based at least in part on the noise covariance matrix estimation reference signal.

In some implementations, a non-transitory computer-readable medium storing a set of instructions for wireless communication includes one or more instructions that, when executed by one or more processors of a network node, cause the network node to: transmit, in a slot associated with a SLIV that spans multiple slots, a noise covariance matrix estimation reference signal in accordance with a frequency domain window and a time domain window; and receive a report that indicates an interference from a neighboring cell, wherein the interference is measured in the slot based at least in part on the noise covariance matrix estimation reference signal.

In some implementations, an apparatus for wireless communication includes means for receiving, in a slot associated with a SLIV that spans multiple slots, a noise covariance matrix estimation reference signal in accordance with a frequency domain window and a time domain window; and means for transmitting a report that indicates an interference from a neighboring cell, wherein the interference is measured in the slot based at least in part on the noise covariance matrix estimation reference signal.

In some implementations, an apparatus for wireless communication includes means for transmitting, in a slot associated with a SLIV that spans multiple slots, a noise covariance matrix estimation reference signal in accordance with a frequency domain window and a time domain window; and means for receiving a report that indicates an interference from a neighboring cell, wherein the interference is measured in the slot based at least in part on the noise covariance matrix estimation reference signal.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example disaggregated network node architecture, in accordance with the present disclosure.

FIG. 3 is a diagram illustrating an example of a demodulation reference signal (DMRS) sharing across start and length indicator values (SLIVs), in accordance with the present disclosure.

FIG. 4 is a diagram illustrating an example of noise covariance matrix averaging boundaries, in accordance with the present disclosure.

FIG. 5 is a diagram illustrating an example of bursty interference, in accordance with the present disclosure.

FIGS. 6-8 are diagrams illustrating examples associated with noise covariance matrix estimation reference signals in accordance with SLIVs that span multiple slots, in accordance with the present disclosure.

FIG. 9 is a flowchart illustrating an example process performed, for example, by a UE, in accordance with the present disclosure.

FIG. 10 is a flowchart illustrating an example process performed, for example, by a network node, in accordance with the present disclosure.

FIGS. 11-12 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless communication system, a repeated physical uplink shared channel (PUSCH) or physical downlink shared channel (PDSCH) (PUSCH/PDSCH) transmission with multiple segments of back-to-back symbols may be used to extend a PUSCH/PDSCH coverage. Repetitions of a PUSCH/PDSCH transmission may take different redundancy versions (RVs) of the PUSCH/PDSCH transmission, and each repetition segment may not cross a slot boundary. A long start and length indicator value (SLIV) design may be used to allow a PUSCH/PDSCH allocation to be across the slot boundary, which may avoid complicated designs to extend coverage. A demodulation reference signal (DMRS) overhead reduction design may be employed by applying a more uniform time domain DMRS pattern, which may be based at least in part on a Doppler shift. A group of DMRS symbols within a channel estimation window may be exploited to interpolate a channel, which may serve to reduce a time domain density of a DMRS. A size of the channel estimation window for DMRS bundling may depend on a user equipment (UE) buffer constraint. In one example, a time domain interpolation for a DMRS may be based at least in part on an overlapping sliding channel estimation window.

In a legacy receiver, DMRS symbols may be used to capture a bursty interference and estimate a noise covariance matrix. The bursty interference may be from other cells for edge UEs. Interference cells may be transmitting one slot or one mini-slot. As a variable SLIV and cross-SLIV may result in relatively sparse DMRS symbols for low Doppler shift cases, the bursty interference may impact non-DMRS symbols, where the bursty interference may not be captured in a noise covariance matrix estimation. In one example, to address the bursty interference, the noise covariance matrix may be estimated using dedicated null resource element (REs) (or null tones), which may result in a throughput gain in a low to medium carrier to interference-plus-noise ratio (CINR). However, when the null REs of bursty interference collide with null REs of a target PUSCH/PDSCH, the bursty interference may not be captured, even when using the dedicated null REs. A different cell specific null REs pattern may be used for the target PUSCH/PDSCH to reduce a probability of a null RE collision, but a chance of the null RE collision is still present. Null RE collisions may reduce an effectiveness of bursty interference reduction, thereby degrading an overall system performance.

Various aspects relate generally to noise covariance matrix estimation reference signals. Some aspects more specifically relate to noise covariance matrix estimation reference signals in accordance with SLIVs that span multiple slots. In some examples, a UE may receive, from a network node and in a slot associated with a SLIV that spans multiple slots, a noise covariance matrix estimation reference signal in accordance with a frequency domain window and a time domain window. The noise covariance matrix estimation reference signal may be configured per frequency domain window, and the time domain window may be associated with a start boundary in the slot and an end boundary in the slot. The slot may exclude a DMRS, and other slots in the multiple slots may include a DMRS that is shared among the multiple slots. One noise covariance matrix estimation reference signal RE, associated with the noise covariance matrix estimation reference signal, may be configured every X symbols in the time domain window and every Y tones in the frequency domain window, where X and Y are positive integers. The UE may transmit, to the network node, a report that indicates an interference from a neighboring cell, where the interference may be measured in the slot based at least in part on the noise covariance matrix estimation reference signal.

Particular aspects of the subject matter described in this disclosure can be implemented to realize one or more of the following potential advantages. In some examples, by configuring the noise covariance matrix estimation reference signal in accordance with the frequency domain window and the time domain window, the described techniques can be used by the UE to measure interference from neighboring cells using the noise covariance matrix estimation reference signal. The noise covariance matrix estimation reference signal may allow the UE to detect the interference for SLIVs that span multiple slots, where some slots include a DMRS and other slots do not include any DMRS. The slots that do not include any DMRS may be more likely to experience the interference, as compared to slots that include the DMRS. Since a presence of DMRS may be relatively sparse in the multiple slots, the noise covariance matrix estimation reference signal may allow for the interference to be detected. Without the noise covariance matrix estimation reference signal and due to the relatively sparse DMRS, the interference may otherwise not be captured in a noise covariance matrix estimation. Using the noise covariance matrix estimation reference signal may avoid null RE collisions, which would reduce an effectiveness of bursty interference reduction. A more accurate noise covariance matrix estimation that considers any interference in the slot may help to improve a signal detection, a channel estimation, and/or an interference management. The network node, after being notified of the interference, may take one or more actions (e.g., adjust a scheduling) in view of the interference, thereby improving an overall network performance.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (cMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

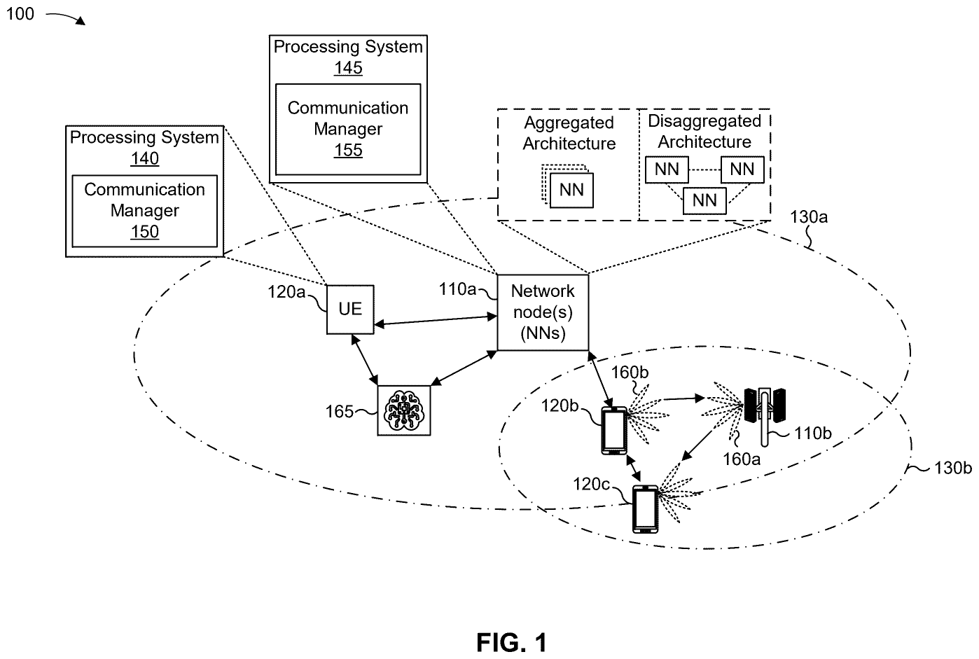

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHZ.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

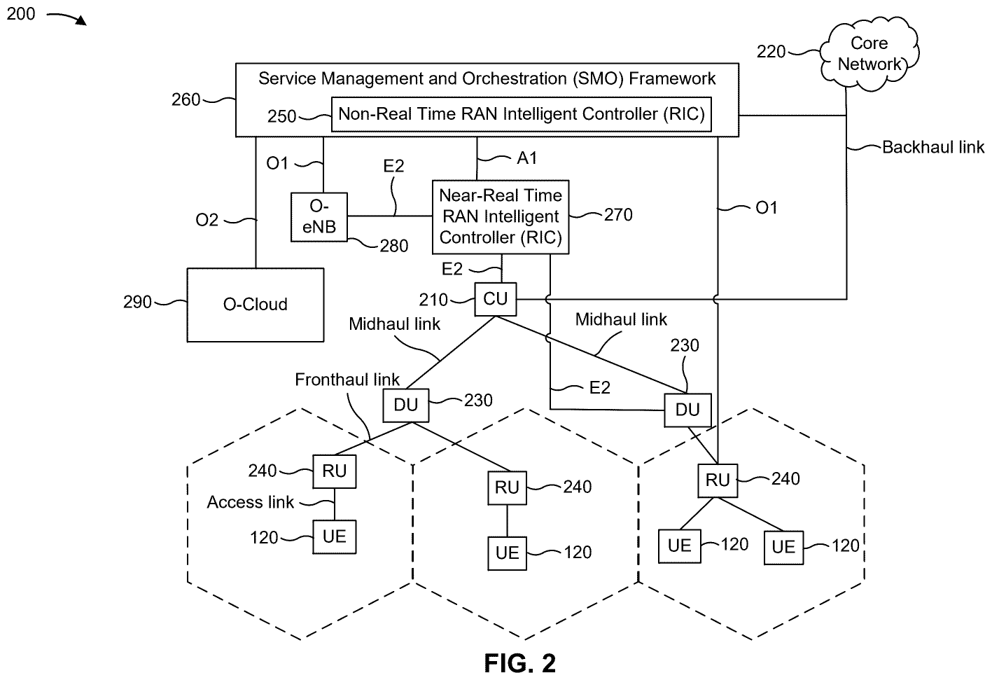

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUS). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks (RBs), and REs), and spatial domain resources (for example, particular transmit directions or beams).

Frequency domain resources may be subdivided into bandwidth parts (BWPs). A BWP may be a block of frequency domain resources (for example, a continuous set of RBs within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal (RS), control information, or data. For example, downlink reference signals include a primary synchronization signal (PSS), a secondary SS (SSS), an SS block (SSB) (for example, that includes a PSS, an SSS, and a physical broadcast channel (PBCH)), a DMRS, a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or RV parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (L1), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mm Wave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, a UE (e.g., the UE 120) may include a communication manager 150. As described in more detail elsewhere herein, the communication manager 150 may receive, in a slot associated with a SLIV that spans multiple slots, a noise covariance matrix estimation reference signal in accordance with a frequency domain window and a time domain window; and transmit a report that indicates an interference from a neighboring cell, wherein the interference is measured in the slot based at least in part on the noise covariance matrix estimation reference signal. Additionally, or alternatively, the communication manager 150 may perform one or more other operations described herein.

In some aspects, a network node (e.g., the network node 110) may include a communication manager 155. As described in more detail elsewhere herein, the communication manager 155 may transmit, in a slot associated with a SLIV that spans multiple slots, a noise covariance matrix estimation reference signal in accordance with a frequency domain window and a time domain window; and receive a report that indicates an interference from a neighboring cell, wherein the interference is measured in the slot based at least in part on the noise covariance matrix estimation reference signal. Additionally, or alternatively, the communication manager 155 may perform one or more other operations described herein.

As indicated above, FIG. 1 is provided as an example. Other examples may differ from what is described with regard to FIG. 1.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-cNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-cNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

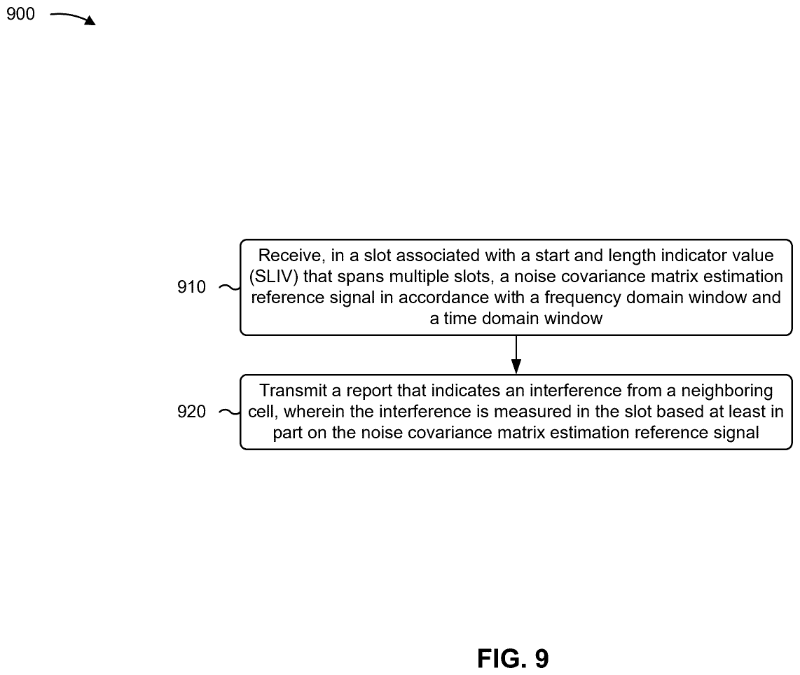

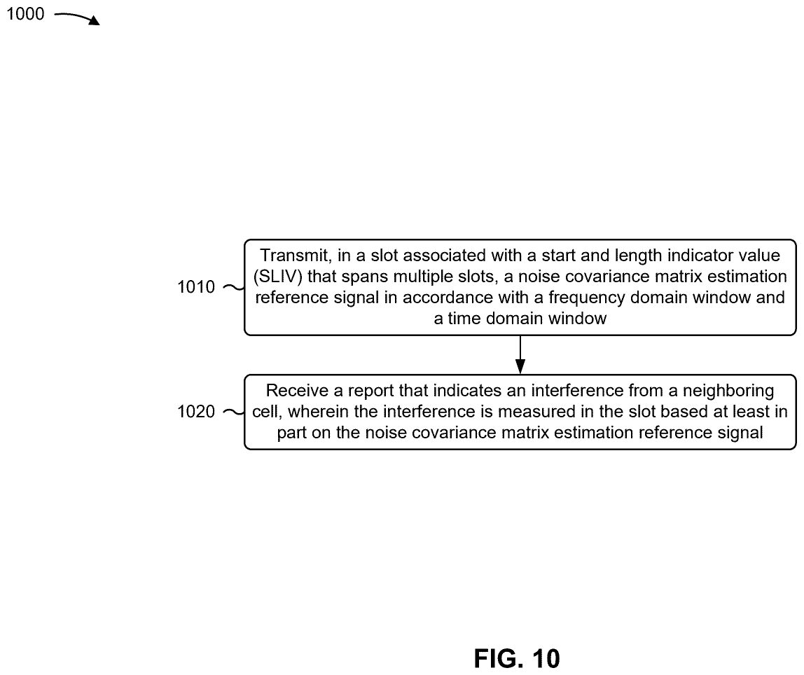

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with noise covariance matrix estimation reference signals in accordance with SLIVs that span multiple slots, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

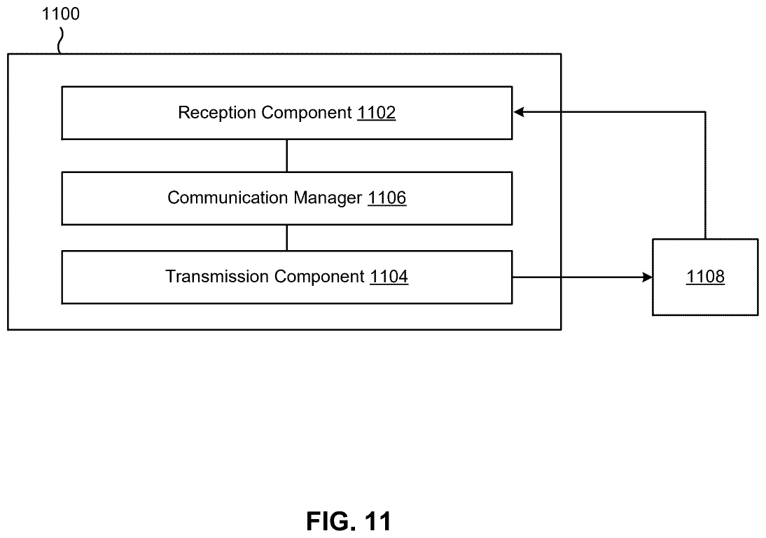

In some aspects, a UE (e.g., the UE 120) includes means for receiving, in a slot associated with a SLIV that spans multiple slots, a noise covariance matrix estimation reference signal in accordance with a frequency domain window and a time domain window; and/or means for transmitting a report that indicates an interference from a neighboring cell, wherein the interference is measured in the slot based at least in part on the noise covariance matrix estimation reference signal. The means for the UE to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

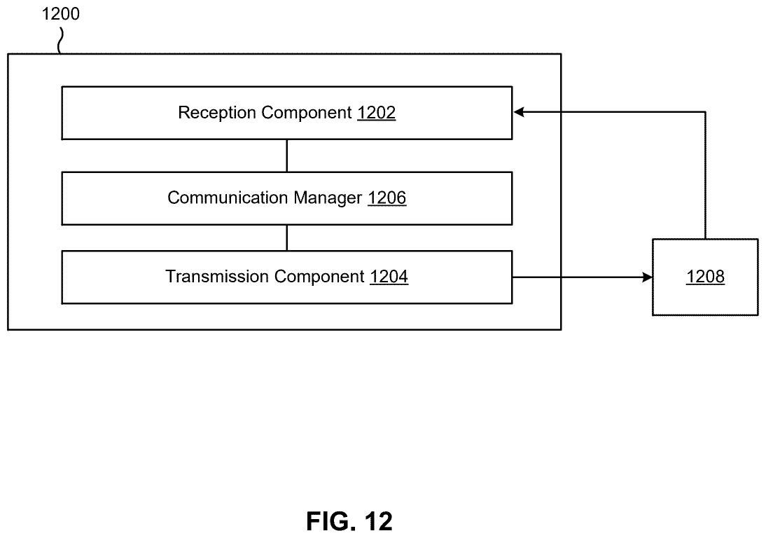

In some aspects, a network node (e.g., the network node 110) includes means for transmitting, in a slot associated with a SLIV that spans multiple slots, a noise covariance matrix estimation reference signal in accordance with a frequency domain window and a time domain window; and/or means for receiving a report that indicates an interference from a neighboring cell, wherein the interference is measured in the slot based at least in part on the noise covariance matrix estimation reference signal. The means for the network node to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

As indicated above, FIG. 2 is provided as an example. Other examples may differ from what is described with regard to FIG. 2.

In an NR system, a repeated PUSCH/PDSCH transmission with multiple segments of back-to-back symbols may be used to extend a PUSCH/PDSCH coverage. Repetitions of a PUSCH/PDSCH transmission may take different RVs of the PUSCH/PDSCH transmission, and each repetition segment may not cross a slot boundary. A long SLIV design may be used to allow a PUSCH/PDSCH allocation to be across the slot boundary, which may avoid complicated designs to extend coverage. A DMRS overhead reduction design may be employed by applying a more uniform time domain DMRS pattern, which may be based at least in part on a Doppler shift. A group of DMRS symbols within a channel estimation window may be exploited to interpolate a channel, which may serve to reduce a time domain density of DMRS. A size of the channel estimation window for DMRS bundling may depend on a UE buffer constraint. In one example, a time domain interpolation for DMRS may be based at least in part on an overlapping sliding channel estimation window.

A DMRS sharing across SLIVs may be supported. For a downlink, a combinable DRS resource in adjacent transmission time intervals (TTIs) may be indicated to a UE, and the UE may be instructed to perform a cross-SLIV combining, which may reduce a DMRS overhead. In some low Doppler shift cases, when a cross-slot DMRS pattern is used, some slots may not have any DMRS.

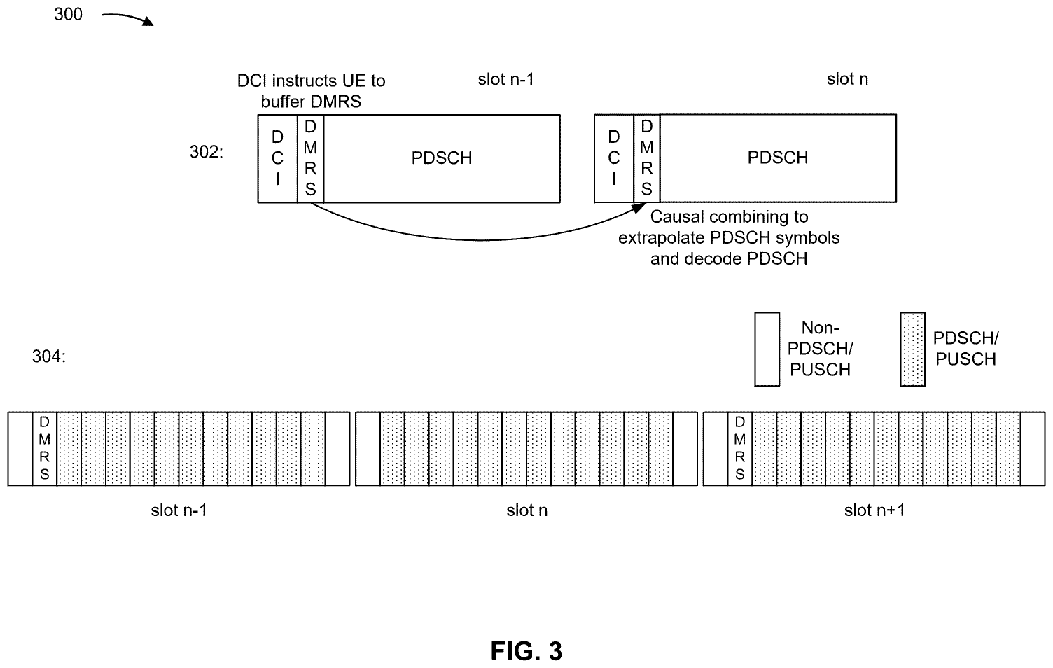

FIG. 3 is a diagram illustrating an example 300 of a DMRS sharing across SLIVs, in accordance with the present disclosure.

As shown by reference number 302, in a first slot (slot n−1), a network node may transmit DCI. The DCI may instruct a first UE to buffer a DMRS. In the first slot, the network node may transmit the DMRS. In the first slot, the network node may transmit a PDSCH transmission, which may be received by the first UE and/or a second UE. In a second slot (slot n), the network node may transmit a DCI, a DMRS, and a PDSCH transmission, which may be received by the first UE. The first UE may utilize a causal combining of DMRS resources to extrapolate PDSCH symbols and decode the PDSCH transmission. As shown by reference number 304, a cross-SLIV DMRS pattern may be employed. A DMRS associated with slot n−1 may be used for slot n. The DMRS associated with slot n−1 may be combined with a DMRS associated with slot n+1. Combining DMRS resource across different slots may reduce a DMRS overhead.

As indicated above, FIG. 3 is provided as an example. Other examples may differ from what is described with regard to FIG. 3.

Various interference estimation algorithms may be employed for interference estimation. In a first interference estimation algorithm, the interference estimation may be only based on DMRS. A channel estimation may be performed first, and then a noise may be computed in accordance with:

$${\hat{R}}_{N N} = \frac{1}{N} \sum ( {Y}_{i} - {H}_{i} ) {( {Y}_{i} - {H}_{i} )}^{′} ,$$

where \hat{R}_{NN} is a noise covariance matrix, N is a number of \hat{R}_{NN} reference signal REs, Yᵢ is a received signal at \hat{R}_{NN} reference signal RE i,

$${Y}_{i}^{′}$$

is a matrix transpose and conjugate of Yᵢ, Hᵢ is a estimated channel at \hat{R}_{NN} reference signal RE i, and

$${H}_{i}^{′}$$

is a matrix transpose and conjugate of Hᵢ. The noise covariance matrix may be used for estimation a noise direction. The first interference estimation algorithm may be robust in persistent and no interference cases, but may not capture a bursty interference. In a second interference estimation algorithm, the interference estimation may be based at least in part on a combination of DMRS and null tones. The null tones may be used for non-DMRS symbols. The second interference estimation algorithm may capture bursty noise, but may lose performance in persistent and no interference cases. In a third interference estimation algorithm, \hat{R}_{NN} may be estimated from data tones. For symbol i, a first value (R_{yy}) may be computed in accordance with

$${R}_{y y} = \frac{1}{N} \sum {Y}_{i} {Y}_{i}^{′} \approx \frac{1}{N} \sum {\hat{H}}_{i} \cdot {\hat{H}}_{i}^{′} + Δ {H}_{i} Δ {H}_{i}^{′} + {G}_{i} \cdot {G}_{i}^{′} + {n}_{i} \cdot {n}_{i}^{′}$$

(cross terms ignored), and

$${\hat{R}}_{NN} = {R}_{yy} - \frac{1}{N} \sum {\hat{H}}_{i} \cdot {\hat{H}}_{i}^{′} - {N}_{0} I ,$$

where Gᵢ is an interference channel response at \hat{R}_{NN} reference signal RE i, N₀ is a thermal noise variance, and/is an identity matrix. The third interference estimation algorithm may capture a spatial signature, may be suitable for rank 1 interference, and may not have rate loss, but the third interference estimation algorithm may need a relatively large number of samples to achieve an accurate \hat{R}_{NN} estimation.

Time domain and/or frequency domain noise covariance matrix averaging boundaries based at least in part on an interference pattern may be used, such that a receiver is able to average a noise covariance matrix estimation from a data tone or null/RS tones within a time/frequency domain window as much as possible to improve an accuracy of a noise covariance matrix estimation. A frequency domain noise covariance matrix window may be aligned with a minimum precoding resource block group (PRG) size in a network. A time domain noise covariance matrix averaging start and end boundary may be related to a potential SLIV pattern in the network.

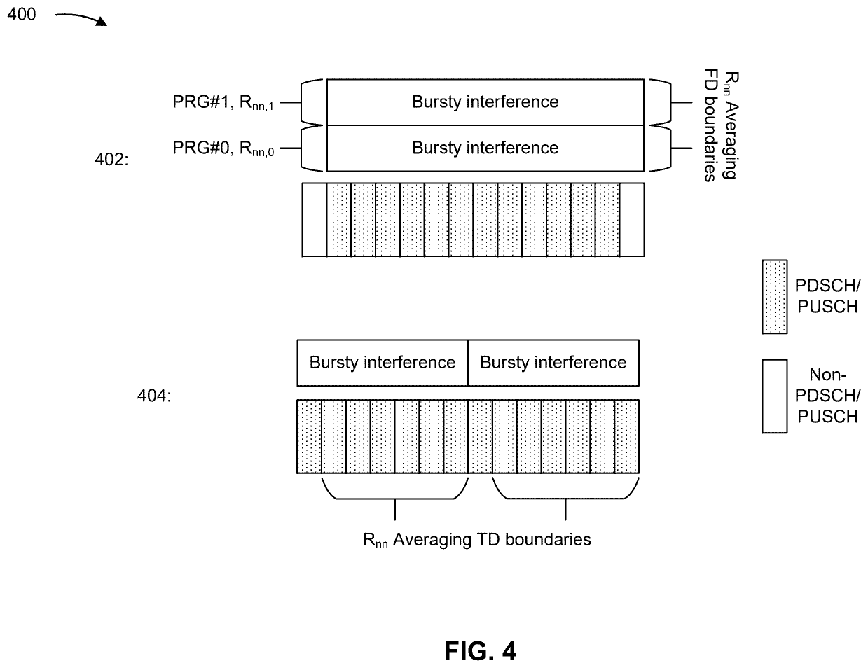

FIG. 4 is a diagram illustrating an example 400 of noise covariance matrix averaging boundaries, in accordance with the present disclosure.

As shown by reference number 402, a slot may be associated with a PUSCH/PDSCH transmission. A frequency domain (FD) noise covariance matrix window may be aligned with a minimum PRG size. For example, for bursty interference, a frequency domain \hat{R}_{NN} averaging boundary may be associated with a first PRG (R_{nn,0}). As another example, for bursty interference, a frequency domain \hat{R}_{NN} averaging boundary may be associated with a second PRG (R_{nn,1}). In these examples, bursty interference may be across the entire slot (e.g., the bursty interference may be associated with a same direction). As shown by reference number 404, a time domain (TD) noise covariance matrix window may depend on a start and end boundary associated with a SLIV pattern. For example, within the slot, a first bursty interference may be associated with a first half of the slot and a second bursty interference may be associated with a second half of the slot. The first bursty interference may be associated with a first direction and the second bursty interference may be associated with a second direction. In this example, the slot may be associated with two TD \hat{R}_{NN} averaging boundaries, where a first TD \hat{R}_{NN} averaging boundary may be associated with the first bursty interference and a second TD \hat{R}_{NN} averaging boundary may be associated with the second bursty interference.

As indicated above, FIG. 4 is provided as an example. Other examples may differ from what is described with regard to FIG. 4.

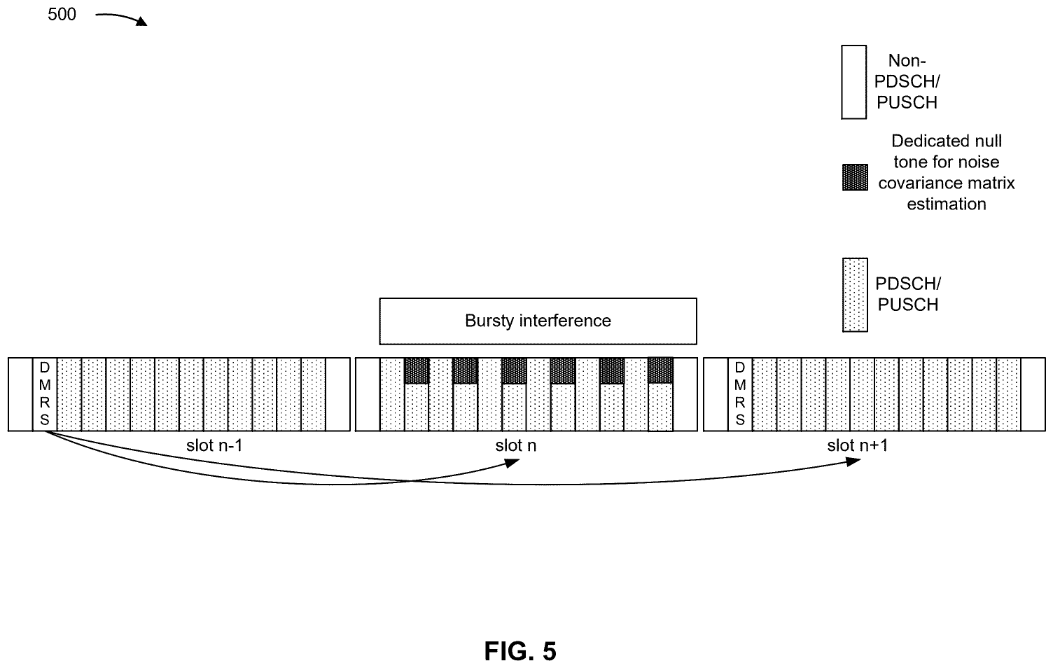

FIG. 5 is a diagram illustrating an example 500 of bursty interference, in accordance with the present disclosure.

As shown in FIG. 5, a first slot (slot n−1), a second slot (slot n), and a third slot (slot n+1) may be associated with a PUSCH/PDSCH. The first slot may be used to transmit a DMRS. The second slot may not include any DMRS. The third slot may be used to transmit a DMRS. A cross-SLIV DMRS combining may be used for the second slot. In other words, the second slot may utilize the DMRS from the first slot. A cross-SLIV DMRS combining may be used for the third slot. In other words, the DMRS associated with the first slot may be utilized along with the DMRS associated with the third slot. Further, the second slot may be associated with bursty interference, which may be based at least in part on the second slot not including any DMRS. The second slot may include a plurality of dedicated null tones, which may be used for estimating a noise covariance matrix. The dedicated null tones may be noise covariance matrix estimation reference signals.

As indicated above, FIG. 5 is provided as an example. Other examples may differ from what is described with regard to FIG. 5.

In a legacy NR receiver, DMRS symbols may be used to capture a bursty interference and estimate a noise covariance matrix (\hat{R}_{NN}). The bursty interference may be from other cells for edge UEs. Interference cells may be transmitting one slot or one mini-slot. As a variable SLIV and cross-SLIV may result in relatively sparse DMRS symbols for low Doppler shift cases, the bursty interference may impact non-DMRS symbols, where the bursty interference may not be captured in a noise covariance matrix (\hat{R}_{NN}) estimation. In one example, to address the bursty interference, the noise covariance matrix may be estimated using dedicated null REs (or null tones), which may result in a throughput gain in a low to medium CINR. However, when the null REs of bursty interference collide with null REs of a target PUSCH/PDSCH, the bursty interference may not be captured, even when using the dedicated null REs. A different cell specific null REs pattern may be used for the target PUSCH/PDSCH to reduce a probability of a null RE collision, but a chance of the null RE collision is still present. Further, using zero power null RE patterns may not be feasible. Null RE collisions may reduce an effectiveness of bursty interference reduction, thereby degrading an overall system performance.

In various aspects of techniques and apparatuses described herein, a UE may receive, from a network node and in a slot associated with a SLIV that spans multiple slots, a noise covariance matrix estimation reference signal in accordance with a frequency domain window and a time domain window. The noise covariance matrix estimation reference signal may be configured per frequency domain window, and the time domain window may be associated with a start boundary in the slot and an end boundary in the slot. The slot may exclude a DMRS, and other slots in the multiple slots may include a DMRS that is shared among the multiple slots. One noise covariance matrix estimation reference signal RE, associated with the noise covariance matrix estimation reference signal, may be configured every X symbols in the time domain window and every Y tones in the frequency domain window, where X and Y are positive integers. The UE may transmit, to the network node, a report that indicates an interference from a neighboring cell, where the interference may be measured in the slot based at least in part on the noise covariance matrix estimation reference signal.

In some aspects, the noise covariance channel estimation reference signal may be based at least in part on a PTRS framework. A density of the noise covariance channel estimation reference signal may be relatively sparse in the time domain window and/or the frequency domain window. Using the noise covariance channel estimation reference signal may result in a favorable throughput performance, which may be similar to a throughput performance of null tones when a channel estimation is favorable. When using the noise covariance channel estimation reference signal, a channel estimation may be needed before noise covariance matrix estimation. The usage of the noise covariance channel estimation reference signal may be useful in the context of a long SLIV transmission across the multiple slots, where DMRS symbols are relatively sparse for low Doppler shift scenarios, which may result in interference to non-DMRS symbols that cannot be captured in traditional noise covariance channel estimation. The long SLIV transmission across the multiple slots may be associated with varying interference (e.g., bursty interference in one slot but no interference in other slots). The noise covariance channel estimation reference signal may be transmitted alongside DMRS for the long SLIV transmission across the multiple slots, where a noise (\hat{R}_{NN}) may be changing across allocated symbols and the DMRS may be too sparse to capture noise covariance matrix variations. The noise covariance channel estimation reference signal may be adapted to noise covariance matrix boundaries in the time domain window and/or the frequency domain window.

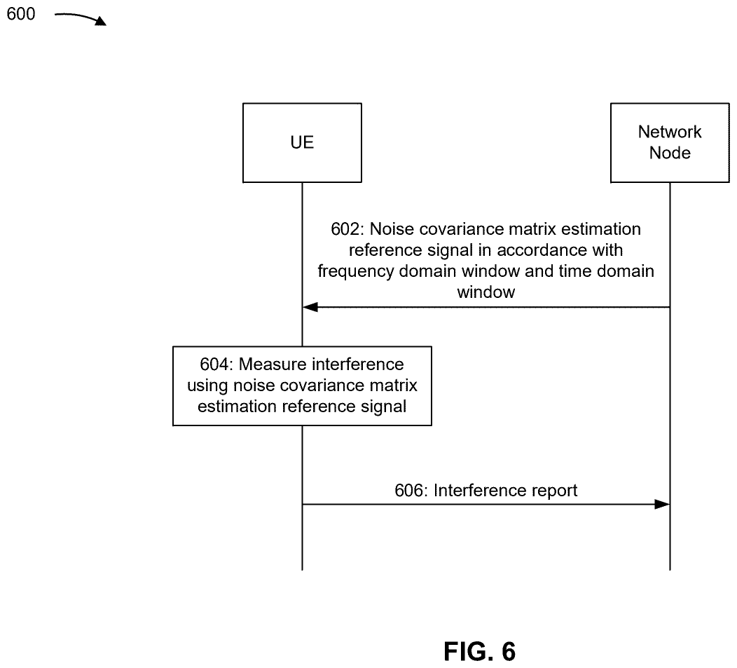

FIG. 6 is a diagram illustrating an example 600 associated with noise covariance matrix estimation reference signals in accordance with SLIVs that span multiple slots, in accordance with the present disclosure. As shown in FIG. 6, example 600 includes communication between a UE (e.g., UE 120) and a network node (e.g., network node 110). In some aspects, the UE and the network node may be included in a wireless network, such as wireless network 100.

As shown by reference number 602, the UE may receive (e.g., using reception component 1102 and/or communication manager 1106, depicted in FIG. 11), from the network node in a slot associated with a SLIV that spans multiple slots, a noise covariance matrix estimation reference signal in accordance with a frequency domain window and a time domain window. The noise covariance matrix estimation reference signal may be configured per frequency domain window, and the time domain window may be associated with a start boundary in the slot and an end boundary in the slot. The slot may exclude a DMRS, and other slots in the multiple slots may include a DMRS that is shared among the multiple slots. One noise covariance matrix estimation reference signal RE, associated with the noise covariance matrix estimation reference signal, may be configured every X symbols in the time domain window and every Y tones in the frequency domain window, where X and Y are positive integers.

In some aspects, by reusing a PTRS sequence, the noise covariance matrix estimation reference signal may be configured within each PRG, which may allow for a noise covariance matrix estimation in each window within the SLIV without the DMRS. On an i-th OFDM symbol, an Nᵣₓ receiver vector after descrambling the noise covariance matrix estimation reference signal may be given by: Yᵢ=Hᵢ+Gᵢwᵢ+nᵢ in a PTRS REs. After estimating a channel Ĥᵢ from the DMRS, the UE may compute the noise covariance matrix in accordance with:

$${\hat{R}}_{NN} = \frac{1}{N} \sum ( {Y}_{i} - {\hat{H}}_{i} ) {( {Y}_{i} - {\hat{H}}_{i} )}^{′} .$$

In some aspects, by taking a PTRS as a baseline, the noise covariance matrix estimation reference signal may be configured per frequency domain window, and the noise covariance matrix estimation reference signal may be based at least in part on a time domain noise covariance matrix averaging start boundary and a time domain noise covariance matrix averaging end boundary. The network node may configure noise covariance matrix estimation reference signals associated with a relatively low density per time domain window (per time segment) and per frequency domain window, which may allow the UE to measure bursty interference from neighboring cells. On the other hand, a legacy PTRS may be configured per SLIV and per a frequency domain resource allocation (FDRA), such that the legacy PTRS may not be suitable for capturing bursty interference. The noise covariance matrix estimation reference signals may be based at least in part on a PTRS sequence generation. The noise covariance matrix estimation reference signals may be transmitted along with one or more PDSCH transmissions, where the one or more PDSCH transmissions may span across a long SLIV associated with multiple slots, where some slots may include a DMRS and other slots may not include a DMRS.

In some aspects, the legacy PTRS may be configured to occupy one RE every 1, 2, or 4 symbols and every 2 or 4 RBs within the FDRA. A PTRS time density may depend on an MCS, where a higher MCS may correspond to a higher PTRS time density. A PTRS frequency density may depend on the FDRA, where a larger FDRA may correspond to a smaller PTRS frequency density. In this case, the noise covariance matrix estimation may be per frequency domain window (e.g., per PRG) and per time domain window, so a finer granularity control on a noise covariance matrix estimation reference signal density may be needed to ensure an appropriate number of noise covariance matrix estimation reference signal REs in each frequency domain window and time domain window.

In some aspects, the network node may configure one noise covariance matrix estimation reference signal RE every X symbols in the time domain window and every Y tones in the frequency domain window, where X and Y are positive integers. For inter-cell interference, a total number of N noise covariance matrix estimation reference signal REs to achieve a favorable throughput performance may depend on a CINR. When the bursty interference is relatively uniform across one frequency domain window (e.g., one PRG) and time domain window, the network node may configure X and Y to produce N′ noise covariance matrix estimation reference signal REs, where N′ is greater than N, but N′ may be selected to minimize overhead.

In some aspects, the slot may be associated with a PDSCH. The noise covariance matrix estimation reference signal may be a multi-layer noise covariance matrix estimation reference signal that is associated with a multi-layer PDSCH transmission. The multi-layer noise covariance matrix estimation reference signal may be associated with a same number of layers and a same precoder as the PDSCH. The multi-layer noise covariance matrix estimation reference signal may be associated with different streams of the noise covariance matrix estimation reference signal that are uncorrelated from each other. The different streams may be generated from different random generators or generated from a same random generator with different initial seeds.

In some aspects, for the multi-layer PDSCH transmission, the noise covariance matrix estimation reference signal may need to maintain a spatial signature of the PDSCH, such that when an interference cell's noise covariance matrix estimation reference signal collides with the noise covariance matrix estimation reference signal in a target cell, a target UE is still able to estimate a rank-more-than-one bursty interference from the interference cell. In some aspects, for the multi-layer PDSCH transmission, the noise covariance matrix estimation reference signal (from the target cell) may have a same number of layers and a same precoder as in the PDSCH. For an L-layer PDSCH, L streams of the noise covariance matrix estimation reference signal may be configured and mapped to L ports of the PDSCH, where L is a positive integer. The L streams of the noise covariance matrix estimation reference signal may result in a multi-layer noise covariance matrix estimation reference signal. Different streams of the noise covariance matrix estimation reference signal may be uncorrelated and may be generated from different random generators, or the different streams of the noise covariance matrix estimation reference signal may be generated using the same random generator with different initial seeds (e.g., an initial seed as a function of a layer index). The same precoder as in the PDSCH may be applied to the multi-layer noise covariance matrix estimation reference signal. On an i-th OFDM symbol, an Nᵣₓ receiver vector may be given by: Yᵢ=Hᵢx+Gᵢwᵢ+nᵢ in PTRS REs. After estimating a channel Ĥᵢ from a DMRS and for an L-layer noise covariance matrix estimation reference signal x, the UE may compute the noise covariance matrix in accordance with:

$${\hat{R}}_{NN} = \frac{1}{N} \sum ( {Y}_{i} - {\hat{H}}_{i} x ) {( {Y}_{i} - {\hat{H}}_{i} x )}^{′} .$$

In some aspects, the UE may receive, from the network node, signaling that indicates a pattern for the noise covariance matrix estimation reference signal. The pattern may be associated with a density of noise covariance matrix estimation reference signal REs. The density may be based at least in part on the CINR. The signaling may be a layer 1 (L1) signaling, a layer 2 (L2) signaling, or a layer 3 (L3) signaling. The pattern for the noise covariance matrix estimation reference signal may be specific to a time domain window. The signaling may be received via DCI that carries a pattern index that is applicable to the time domain window.

In some aspects, the total number of N noise covariance matrix estimation reference signal REs per frequency domain window and per time domain window to achieve the favorable throughput performance may depend on the CINR. For a lower CINR, the UE may need a higher number of noise covariance matrix estimation reference signal REs to estimate the bursty interference. In the case of a very low CINR, an approach of no null REs may be sufficient and the noise covariance matrix estimation reference signals may be turned off. For different CINRs, the noise covariance matrix estimation reference signal density may need to be adapted accordingly.

In some aspects, for a noise covariance matrix estimation reference signal density adaptation, the network node may define different noise covariance matrix estimation reference signal patterns for different densities of the N noise covariance matrix estimation reference signal REs (e.g., different density N values). The network node may transmit, to the UE, signaling to adapt the different noise covariance matrix estimation reference signal patterns. The signaling may be the L1 signaling, the L2 signaling, or the L3 signaling. The network node may use RRC signaling to configure multiple noise covariance matrix estimation reference signal patterns with different density N values. Depending on expected CINR values, the network node may utilize the signaling to indicate or configure an exact noise covariance matrix estimation reference RE pattern.

In some aspects, by using a burst interference prediction, the network node may determine predicted CINR values for each time segment within the long SLIV associated with the multiple slots, which may allow the network node to dynamically signal, to the UE, noise covariance matrix estimation reference RE pattern indices for each time domain window. In this example, the DCI may carry a noise covariance matrix estimation reference RE pattern index for each time domain window within the long SLIV associated with the multiple slots.

In some aspects, the UE may receive, from the network node, a configuration of MCS values and corresponding densities of noise covariance matrix estimation reference signal REs. The UE may identify, from the configuration, a density of noise covariance matrix estimation reference signal REs based at least in part on a scheduled MCS value. One noise covariance matrix estimation reference signal RE may be configured every X symbols in the time domain window and every Y tones in the frequency domain window in accordance with the density, where X and Y are positive integers.

In some aspects, the noise covariance matrix estimation reference signal density adaptation may depend on the MCS. The network node may configure, via RRC signaling, MCS thresholds for the total number of N noise covariance matrix estimation reference signal REs (or density N value), where a time domain density (X) and a frequency domain density (Y) may be configured for each N value. Depending on a scheduled MCS value, the network node and/or the UE may determine values for X and Y, which may correspond to a particular noise covariance matrix estimation reference signal density. The network node may configure, via the RRC signaling, the MCS thresholds for different noise covariance matrix estimation reference signal density N values (e.g., number of noise covariance matrix estimation reference signal REs per time domain window (X) and per frequency domain window (Y)). A lower MCS may correspond to a higher number of noise covariance matrix estimation reference signal REs that are needed by the UE. In the case of a very low MCS, the approach of no null REs may be sufficient and the noise covariance matrix estimation reference signals may be turned off. The network node may configure, via RRC, the time domain density (X) and the frequency domain density (Y) for different N values, which may result in a one-to-one mapping between the scheduled MCS and (X, Y). Depending on the scheduled MCS value, the UE may be able to determine (X, Y), which may allow the UE to receive the noise covariance matrix estimation reference signals from the network node.

As shown by reference number 604, the UE may measure (e.g., using communication manager 1106, depicted in FIG. 11) an interference from a neighboring cell in the slot using the noise covariance matrix estimation reference signal. The interference may be a bursty interference, which may be based at least in part on the slot not being associated with any DMRS. Although the other slots in the multiple slots associated with the SLIV may include one or more DMRSs, the slot without any DMRS may be subjected to the bursty interference. By measuring the noise covariance matrix estimation reference signal, the UE may be able to detect whether the slot is associated with the bursty interference.

As shown by reference number 606, the UE may transmit (e.g., using transmission component 1104 and/or communication manager 1106, depicted in FIG. 11), to the network node, a report that indicates the interference from the neighboring cell, wherein the interference may be measured in the slot based at least in part on the noise covariance matrix estimation reference signal. In one example, the report may indicate that the slot without any DMRS is associated with the bursty interference. Alternatively, the report may indicate the slot without any DMRS is not associated with the bursty interference. The network node may take one or more actions (e.g., adjust a scheduling) depending on the report received from the UE.

As indicated above, FIG. 6 is provided as an example. Other examples may differ from what is described with regard to FIG. 6.

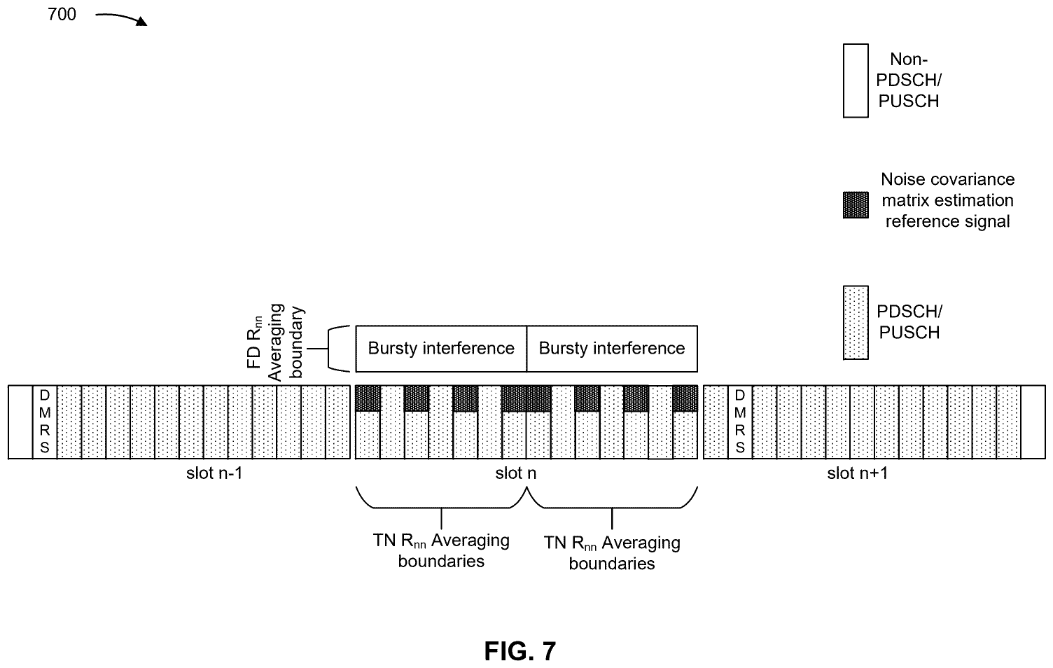

FIG. 7 is a diagram illustrating an example 700 associated with noise covariance matrix estimation reference signals in accordance with SLIVs that span multiple slots, in accordance with the present disclosure.

As shown in FIG. 7, a first slot (slot n−1), a second slot (slot n), and a third slot (slot n+1) may be associated with a PUSCH/PDSCH. The first slot may be used to transmit a DMRS. The second slot may not include any DMRS. The third slot may be used to transmit a DMRS. The second slot may be associated with bursty interference, which may be based at least in part on the second slot not including any DMRS. The second slot may include a plurality of noise covariance matrix estimation reference signals, which may be used for estimating a noise covariance matrix. The noise covariance matrix may be used to measure bursty interference from neighboring cells. The plurality of noise covariance matrix estimation reference signals may be configured in accordance with a frequency domain window (frequency domain noise covariance matrix averaging boundary). The plurality of noise covariance matrix estimation reference signals may be configured in accordance with one or more time domain windows, where each time domain window may be associated with a start boundary and an end boundary. In this example, within the second slot, a first bursty interference may be associated with a first half of the slot and a second bursty interference may be associated with a second half of the slot. The first bursty interference may be associated with a first direction and the second bursty interference may be associated with a second direction. A first time domain window may be defined for the first bursty interference and a second time domain window may be defined for the second bursty interference.

As indicated above, FIG. 7 is provided as an example. Other examples may differ from what is described with regard to FIG. 7.

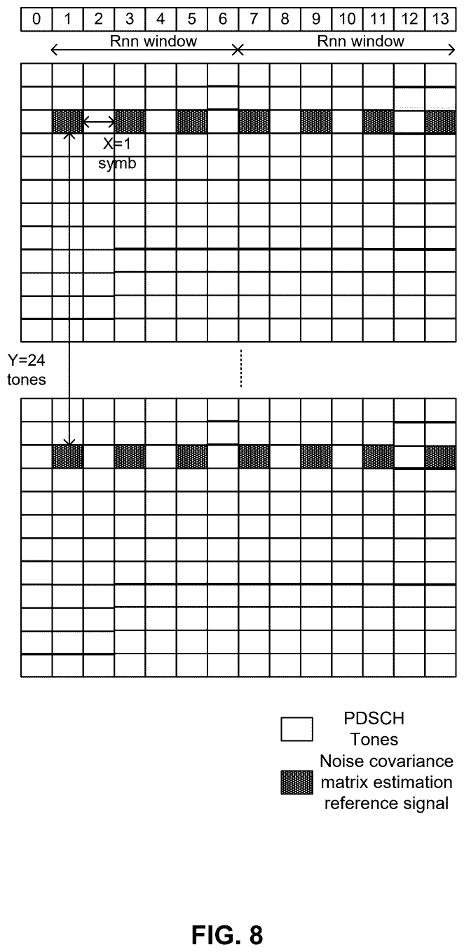

FIG. 8 is a diagram illustrating an example 800 associated with noise covariance matrix estimation reference signals in accordance with SLIVs that span multiple slots, in accordance with the present disclosure.

As shown in FIG. 8, in a given slot, a first seven symbols may be associated with a first time domain window and a last seven symbols may be associated with a second time domain window. The first time domain window may be a first TD \hat{R}_{NN} averaging boundary and the second time domain window may be a second TD \hat{R}_{NN} averaging boundary. Within the slot, starting from a second symbol, every other symbol in a time domain may be utilized for transmitting one or more noise covariance matrix estimation reference signals. Other symbols in the time domain may be associated with a PDSCH. The one or more noise covariance matrix estimation reference signals may be repeated in a frequency domain in accordance with a frequency domain window. The frequency domain window may be an FD \hat{R}_{NN} averaging boundary. In this example, the frequency domain window may span 24 tones. In other words, the one or more noise covariance matrix estimation reference signals may be repeated in the frequency domain every 24 tones.

As indicated above, FIG. 8 is provided as an example. Other examples may differ from what is described with regard to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with noise covariance matrix estimation reference signals in accordance with SLIVs that span multiple slots.

As shown in FIG. 9, in some aspects, process 900 may include receiving, in a slot associated with a SLIV that spans multiple slots, a noise covariance matrix estimation reference signal in accordance with a frequency domain window and a time domain window (block 910). For example, the UE (e.g., using reception component 1102 and/or communication manager 1106, depicted in FIG. 11) may receive, in a slot associated with a SLIV that spans multiple slots, a noise covariance matrix estimation reference signal in accordance with a frequency domain window and a time domain window, as described above in connection with FIGS. 6-8.

As further shown in FIG. 9, in some aspects, process 900 may include transmitting a report that indicates an interference from a neighboring cell, wherein the interference is measured in the slot based at least in part on the noise covariance matrix estimation reference signal (block 920). For example, the UE (e.g., using transmission component 1104 and/or communication manager 1106, depicted in FIG. 11) may transmit a report that indicates an interference from a neighboring cell, wherein the interference is measured in the slot based at least in part on the noise covariance matrix estimation reference signal, as described above in connection with FIGS. 6-8.

Process 900 may include additional aspects, such as any single aspect or any combination of aspects described below and/or in connection with one or more other processes described elsewhere herein.

In a first aspect, the noise covariance matrix estimation reference signal is configured per frequency domain window, and the time domain window is associated with a start boundary in the slot and an end boundary in the slot.

In a second aspect, alone or in combination with the first aspect, the slot excludes a DMRS, and other slots in the multiple slots include a DMRS that is shared among the multiple slots.

In a third aspect, alone or in combination with one or more of the first and second aspects, one noise covariance matrix estimation reference signal RE, associated with the noise covariance matrix estimation reference signal, is configured every X symbols in the time domain window and every Y tones in the frequency domain window, and X and Y are positive integers.

In a fourth aspect, alone or in combination with one or more of the first through third aspects, the slot is associated with a PDSCH, wherein the noise covariance matrix estimation reference signal is a multi-layer noise covariance matrix estimation reference signal that is associated with a multi-layer PDSCH transmission, and the multi-layer noise covariance matrix estimation reference signal is associated with a same number of layers and a same precoder as the PDSCH.

In a fifth aspect, alone or in combination with one or more of the first through fourth aspects, the multi-layer noise covariance matrix estimation reference signal is associated with different streams of the noise covariance matrix estimation reference signal that are uncorrelated from each other, and the different streams are generated from different random generators or generated from a same random generator with different initial seeds.

In a sixth aspect, alone or in combination with one or more of the first through fifth aspects, process 900 includes receiving signaling that indicates a pattern for the noise covariance matrix estimation reference signal, wherein the pattern is associated with a density of noise covariance matrix estimation reference signal REs, and the density is based at least in part on a CINR.

In a seventh aspect, alone or in combination with one or more of the first through sixth aspects, the signaling is an L1 signaling, a an L2 signaling, or an L3 signaling.

In an eighth aspect, alone or in combination with one or more of the first through seventh aspects, the pattern for the noise covariance matrix estimation reference signal is specific to a time domain window, and the signaling is received via DCI that carries a pattern index that is applicable to the time domain window.

In a ninth aspect, alone or in combination with one or more of the first through eighth aspects, process 900 includes receiving a configuration of MCS values and corresponding densities of noise covariance matrix estimation reference signal REs, and identifying, from the configuration, a density of noise covariance matrix estimation reference signal REs based at least in part on a scheduled MCS value, wherein one noise covariance matrix estimation reference signal RE is configured every X symbols in the time domain window and every Y tones in the frequency domain window in accordance with the density, and X and Y are positive integers.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with noise covariance matrix estimation reference signals in accordance with SLIVs that span multiple slots.

As shown in FIG. 10, in some aspects, process 1000 may include transmitting, in a slot associated with a SLIV that spans multiple slots, a noise covariance matrix estimation reference signal in accordance with a frequency domain window and a time domain window (block 1010). For example, the network node (e.g., using transmission component 1204 and/or communication manager 1206, depicted in FIG. 12) may transmit, in a slot associated with a SLIV that spans multiple slots, a noise covariance matrix estimation reference signal in accordance with a frequency domain window and a time domain window, as described above in connection with FIGS. 6-8.

As further shown in FIG. 10, in some aspects, process 1000 may include receiving a report that indicates an interference from a neighboring cell, wherein the interference is measured in the slot based at least in part on the noise covariance matrix estimation reference signal (block 1020). For example, the network node (e.g., using reception component 1202 and/or communication manager 1206, depicted in FIG. 12) may receive a report that indicates an interference from a neighboring cell, wherein the interference is measured in the slot based at least in part on the noise covariance matrix estimation reference signal, as described above in connection with FIGS. 6-8.

Process 1000 may include additional aspects, such as any single aspect or any combination of aspects described below and/or in connection with one or more other processes described elsewhere herein.

In a first aspect, the noise covariance matrix estimation reference signal is configured per frequency domain window, and the time domain window is associated with a start boundary in the slot and an end boundary in the slot.

In a second aspect, alone or in combination with the first aspect, the slot excludes a DMRS, and other slots in the multiple slots include a DMRS that is shared among the multiple slots.

In a third aspect, alone or in combination with one or more of the first and second aspects, one noise covariance matrix estimation reference signal RE, associated with the noise covariance matrix estimation reference signal, is configured every X symbols in the time domain window and every Y tones in the frequency domain window, and wherein X and Y are positive integers.

In a fourth aspect, alone or in combination with one or more of the first through third aspects, the slot is associated with a PDSCH, wherein the noise covariance matrix estimation reference signal is a multi-layer noise covariance matrix estimation reference signal that is associated with a multi-layer PDSCH transmission, and the multi-layer noise covariance matrix estimation reference signal is associated with a same number of layers and a same precoder as the PDSCH.

In a fifth aspect, alone or in combination with one or more of the first through fourth aspects, the multi-layer noise covariance matrix estimation reference signal is associated with different streams of the noise covariance matrix estimation reference signal that are uncorrelated from each other, and the different streams are generated from different random generators or generated from a same random generator with different initial seeds.

In a sixth aspect, alone or in combination with one or more of the first through fifth aspects, process 1000 includes transmitting signaling that indicates a pattern for the noise covariance matrix estimation reference signal, wherein the pattern is associated with a density of noise covariance matrix estimation reference signal REs, and the density is based at least in part on a CINR.

In a seventh aspect, alone or in combination with one or more of the first through sixth aspects, the signaling is an L1 signaling, a an L2 signaling, or an L3 signaling.

In an eighth aspect, alone or in combination with one or more of the first through seventh aspects, the pattern for the noise covariance matrix estimation reference signal is specific to a time domain window, and the signaling is received via DCI that carries a pattern index that is applicable to the time domain window.

In a ninth aspect, alone or in combination with one or more of the first through eighth aspects, process 1000 includes identifying a configuration of MCS values and corresponding densities of noise covariance matrix estimation reference signal REs, and identifying, from the configuration, a density of noise covariance matrix estimation reference signal REs based at least in part on a scheduled MCS value, wherein one noise covariance matrix estimation reference signal RE is configured every X symbols in the time domain window and every Y tones in the frequency domain window in accordance with the density, and X and Y are positive integers.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 6-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, in a slot associated with a SLIV that spans multiple slots, a noise covariance matrix estimation reference signal in accordance with a frequency domain window and a time domain window. The transmission component 1104 may transmit a report that indicates an interference from a neighboring cell, wherein the interference is measured in the slot based at least in part on the noise covariance matrix estimation reference signal.

The reception component 1102 may receive signaling that indicates a pattern for the noise covariance matrix estimation reference signal, wherein the pattern is associated with a density of noise covariance matrix estimation reference signal REs, and the density is based at least in part on a CINR. The reception component 1102 may receive a configuration of MCS values and corresponding densities of noise covariance matrix estimation reference signal REs. The communication manager 1106 may identify, from the configuration, a density of noise covariance matrix estimation reference signal REs based at least in part on a scheduled MCS value, wherein one noise covariance matrix estimation reference signal RE is configured every X symbols in the time domain window and every Y tones in the frequency domain window in accordance with the density, and wherein X and Y are positive integers.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 6-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, in a slot associated with a SLIV that spans multiple slots, a noise covariance matrix estimation reference signal in accordance with a frequency domain window and a time domain window. The reception component 1202 may receive a report that indicates an interference from a neighboring cell, wherein the interference is measured in the slot based at least in part on the noise covariance matrix estimation reference signal.

The transmission component 1204 may transmit signaling that indicates a pattern for the noise covariance matrix estimation reference signal, wherein the pattern is associated with a density of noise covariance matrix estimation reference signal REs, and wherein the density is based at least in part on a CINR. The communication manager 1206 may identify a configuration of MCS values and corresponding densities of noise covariance matrix estimation reference signal REs. The communication manager 1206 may identify, from the configuration, a density of noise covariance matrix estimation reference signal REs based at least in part on a scheduled MCS value, wherein one noise covariance matrix estimation reference signal RE is configured every X symbols in the time domain window and every Y tones in the frequency domain window in accordance with the density, and X and Y are positive integers.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving, in a slot associated with a start and length indicator value (SLIV) that spans multiple slots, a noise covariance matrix estimation reference signal in accordance with a frequency domain window and a time domain window; and transmitting a report that indicates an interference from a neighboring cell, wherein the interference is measured in the slot based at least in part on the noise covariance matrix estimation reference signal.

Aspect 2: The method of Aspect 1, wherein the noise covariance matrix estimation reference signal is configured per frequency domain window, and the time domain window is associated with a start boundary in the slot and an end boundary in the slot.

Aspect 3: The method of any of Aspects 1-2, wherein the slot excludes a demodulation reference signal (DMRS), and wherein other slots in the multiple slots include a DMRS that is shared among the multiple slots.

Aspect 4: The method of any of Aspects 1-3, wherein one noise covariance matrix estimation reference signal resource element (RE), associated with the noise covariance matrix estimation reference signal, is configured every X symbols in the time domain window and every Y tones in the frequency domain window, and wherein X and Y are positive integers.

Aspect 5: The method of any of Aspects 1-4, wherein the slot is associated with a physical downlink shared channel (PDSCH), wherein the noise covariance matrix estimation reference signal is a multi-layer noise covariance matrix estimation reference signal that is associated with a multi-layer PDSCH transmission, and wherein the multi-layer noise covariance matrix estimation reference signal is associated with a same number of layers and a same precoder as the PDSCH.

Aspect 6: The method of Aspect 5, wherein the multi-layer noise covariance matrix estimation reference signal is associated with different streams of the noise covariance matrix estimation reference signal that are uncorrelated from each other, and wherein the different streams are generated from different random generators or generated from a same random generator with different initial seeds.

Aspect 7: The method of any of Aspects 1-6, further comprising: receiving signaling that indicates a pattern for the noise covariance matrix estimation reference signal, wherein the pattern is associated with a density of noise covariance matrix estimation reference signal resource elements (REs), and wherein the density is based at least in part on a carrier to interference-plus-noise ratio (CINR).

Aspect 8: The method of Aspect 7, wherein the signaling is a layer 1 (L1) signaling, a layer 2 (L2) signaling, or a layer 3 (L3) signaling.

Aspect 9: The method of Aspect 7, wherein the pattern for the noise covariance matrix estimation reference signal is specific to a time domain window, and wherein the signaling is received via downlink control information (DCI) that carries a pattern index that is applicable to the time domain window.

Aspect 10: The method of any of Aspects 1-9, further comprising: receiving a configuration of modulation and coding scheme (MCS) values and corresponding densities of noise covariance matrix estimation reference signal resource elements (REs); and identifying, from the configuration, a density of noise covariance matrix estimation reference signal REs based at least in part on a scheduled MCS value, wherein one noise covariance matrix estimation reference signal RE is configured every X symbols in the time domain window and every Y tones in the frequency domain window in accordance with the density, and wherein X and Y are positive integers.

Aspect 11: A method of wireless communication performed by a network node, comprising: transmitting, in a slot associated with a start and length indicator value (SLIV) that spans multiple slots, a noise covariance matrix estimation reference signal in accordance with a frequency domain window and a time domain window; and receiving a report that indicates an interference from a neighboring cell, wherein the interference is measured in the slot based at least in part on the noise covariance matrix estimation reference signal.

Aspect 12: The method of Aspect 11, wherein the noise covariance matrix estimation reference signal is configured per frequency domain window, and the time domain window is associated with a start boundary in the slot and an end boundary in the slot.

Aspect 13: The method of any of Aspects 11-12, wherein the slot excludes a demodulation reference signal (DMRS), and wherein other slots in the multiple slots include a DMRS that is shared among the multiple slots.

Aspect 14: The method of any of Aspects 11-13, wherein one noise covariance matrix estimation reference signal resource element (RE), associated with the noise covariance matrix estimation reference signal, is configured every X symbols in the time domain window and every Y tones in the frequency domain window, and wherein X and Y are positive integers.

Aspect 15: The method of any of Aspects 11-14, wherein the slot is associated with a physical downlink shared channel (PDSCH), wherein the noise covariance matrix estimation reference signal is a multi-layer noise covariance matrix estimation reference signal that is associated with a multi-layer PDSCH transmission, and wherein the multi-layer noise covariance matrix estimation reference signal is associated with a same number of layers and a same precoder as the PDSCH.

Aspect 16: The method of Aspect 15, wherein the multi-layer noise covariance matrix estimation reference signal is associated with different streams of the noise covariance matrix estimation reference signal that are uncorrelated from each other, and wherein the different streams are generated from different random generators or generated from a same random generator with different initial seeds.

Aspect 17: The method of any of Aspects 11-16, further comprising: transmitting signaling that indicates a pattern for the noise covariance matrix estimation reference signal, wherein the pattern is associated with a density of noise covariance matrix estimation reference signal resource elements (REs), and wherein the density is based at least in part on a carrier to interference-plus-noise ratio (CINR).

Aspect 18: The method of Aspect 17, wherein the signaling is a layer 1 (L1) signaling, a layer 2 (L2) signaling, or a layer 3 (L3) signaling.

Aspect 19: The method of Aspect 17, wherein the pattern for the noise covariance matrix estimation reference signal is specific to a time domain window, and wherein the signaling is received via downlink control information (DCI) that carries a pattern index that is applicable to the time domain window.

Aspect 20: The method of any of Aspects 11-19, further comprising: identifying a configuration of modulation and coding scheme (MCS) values and corresponding densities of noise covariance matrix estimation reference signal resource elements (REs); and identifying, from the configuration, a density of noise covariance matrix estimation reference signal REs based at least in part on a scheduled MCS value, wherein one noise covariance matrix estimation reference signal RE is configured every X symbols in the time domain window and every Y tones in the frequency domain window in accordance with the density, and wherein X and Y are positive integers.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive, in a slot associated with a start and length indicator value (SLIV) that spans multiple slots, a noise covariance matrix estimation reference signal in accordance with a frequency domain window and a time domain window; and
transmit a report that indicates an interference from a neighboring cell, wherein the interference is measured in the slot based at least in part on the noise covariance matrix estimation reference signal.

2. The apparatus of claim 1, wherein the noise covariance matrix estimation reference signal is configured per frequency domain window, and the time domain window is associated with a start boundary in the slot and an end boundary in the slot.

3. The apparatus of claim 1, wherein the slot excludes a demodulation reference signal (DMRS), and wherein other slots in the multiple slots include a DMRS that is shared among the multiple slots.

4. The apparatus of claim 1, wherein one noise covariance matrix estimation reference signal resource element (RE), associated with the noise covariance matrix estimation reference signal, is configured every X symbols in the time domain window and every Y tones in the frequency domain window, and wherein X and Y are positive integers.

5. The apparatus of claim 1, wherein the slot is associated with a physical downlink shared channel (PDSCH), wherein the noise covariance matrix estimation reference signal is a multi-layer noise covariance matrix estimation reference signal that is associated with a multi-layer PDSCH transmission, and wherein the multi-layer noise covariance matrix estimation reference signal is associated with a same number of layers and a same precoder as the PDSCH.

6. The apparatus of claim 5, wherein the multi-layer noise covariance matrix estimation reference signal is associated with different streams of the noise covariance matrix estimation reference signal that are uncorrelated from each other, and wherein the different streams are generated from different random generators or generated from a same random generator with different initial seeds.

7. The apparatus of claim 1, wherein the one or more processors are further configured to cause the UE to:
receive signaling that indicates a pattern for the noise covariance matrix estimation reference signal, wherein the pattern is associated with a density of noise covariance matrix estimation reference signal resource elements (REs), and wherein the density is based at least in part on a carrier to interference-plus-noise ratio (CINR).

8. The apparatus of claim 7, wherein the signaling is a layer 1 (L1) signaling, a layer 2 (L2) signaling, or a layer 3 (L3) signaling.

9. The apparatus of claim 7, wherein the pattern for the noise covariance matrix estimation reference signal is specific to a time domain window, and wherein the signaling is received via downlink control information (DCI) that carries a pattern index that is applicable to the time domain window.

10. The apparatus of claim 1, wherein the one or more processors are further configured to cause the UE to:
receive a configuration of modulation and coding scheme (MCS) values and corresponding densities of noise covariance matrix estimation reference signal resource elements (REs); and
identify, from the configuration, a density of noise covariance matrix estimation reference signal REs based at least in part on a scheduled MCS value, wherein one noise covariance matrix estimation reference signal RE is configured every X symbols in the time domain window and every Y tones in the frequency domain window in accordance with the density, and wherein X and Y are positive integers.

11. An apparatus for wireless communication at a network node, comprising:
one or more memories; and
one or more processors, coupled to the one or more memories, configured to cause the network node to:
transmit, in a slot associated with a start and length indicator value (SLIV) that spans multiple slots, a noise covariance matrix estimation reference signal in accordance with a frequency domain window and a time domain window; and
receive a report that indicates an interference from a neighboring cell, wherein the interference is measured in the slot based at least in part on the noise covariance matrix estimation reference signal.

12. The apparatus of claim 11, wherein the noise covariance matrix estimation reference signal is configured per frequency domain window, and the time domain window is associated with a start boundary in the slot and an end boundary in the slot.

13. The apparatus of claim 11, wherein the slot excludes a demodulation reference signal (DMRS), and wherein other slots in the multiple slots include a DMRS that is shared among the multiple slots.

14. The apparatus of claim 11, wherein one noise covariance matrix estimation reference signal resource element (RE), associated with the noise covariance matrix estimation reference signal, is configured every X symbols in the time domain window and every Y tones in the frequency domain window, and wherein X and Y are positive integers.

15. The apparatus of claim 11, wherein the slot is associated with a physical downlink shared channel (PDSCH), wherein the noise covariance matrix estimation reference signal is a multi-layer noise covariance matrix estimation reference signal that is associated with a multi-layer PDSCH transmission, and wherein the multi-layer noise covariance matrix estimation reference signal is associated with a same number of layers and a same precoder as the PDSCH.

16. The apparatus of claim 15, wherein the multi-layer noise covariance matrix estimation reference signal is associated with different streams of the noise covariance matrix estimation reference signal that are uncorrelated from each other, and wherein the different streams are generated from different random generators or generated from a same random generator with different initial seeds.

17. The apparatus of claim 11, wherein the one or more processors are further configured to cause the network node to:
transmit signaling that indicates a pattern for the noise covariance matrix estimation reference signal, wherein the pattern is associated with a density of noise covariance matrix estimation reference signal resource elements (REs), and wherein the density is based at least in part on a carrier to interference-plus-noise ratio (CINR).

18. The apparatus of claim 17, wherein the pattern for the noise covariance matrix estimation reference signal is specific to a time domain window, and wherein the signaling is received via downlink control information (DCI) that carries a pattern index that is applicable to the time domain window.

19. The apparatus of claim 11, wherein the one or more processors are further configured to cause the network node to:
identify a configuration of modulation and coding scheme (MCS) values and corresponding densities of noise covariance matrix estimation reference signal resource elements (REs); and
identify, from the configuration, a density of noise covariance matrix estimation reference signal REs based at least in part on a scheduled MCS value, wherein one noise covariance matrix estimation reference signal RE is configured every X symbols in the time domain window and every Y tones in the frequency domain window in accordance with the density, and wherein X and Y are positive integers.

20. A method of wireless communication performed by a user equipment (UE), comprising:
receiving, in a slot associated with a start and length indicator value (SLIV) that spans multiple slots, a noise covariance matrix estimation reference signal in accordance with a frequency domain window and a time domain window; and
transmitting a report that indicates an interference from a neighboring cell, wherein the interference is measured in the slot based at least in part on the noise covariance matrix estimation reference signal.
